(19) United States
(12) Patent Application Publication
(10) Pub. No.: US 2008/0036756 A1
(43) Pub. Date: Feb. 14, 2008

(54) SYSTEM AND METHODS FOR CONTENT CONVERSION AND DISTRIBUTION

(76) Inventors: Maria Gaos, Bothell, WA (US); Nazih Youssef, Bothell, WA (US)

Correspondence Address: AXIOS LAW GROUP. PLLC, 1525 FOURTH AVENUE, SUITE 800, SEATTLE, WA, 98101, US

(21) Appl. No.: 11/837,419

(22) Filed: Aug. 10, 2007

Related U.S. Application Data
(60) Provisional application No. 60/822,053, filed on Aug. 10, 2006.

(51) Int. Cl. G06F 17/00

(52) U.S. Cl. 345/418

(57) ABSTRACT

A system and method for content conversion comprising a memory and a processor coupled to the memory, the processor operative to generate a request for access to at least one mapped interactive environment, receive a plurality of viewing data generated from one or more viewing resources included in the at least one mapped interactive environment, the viewing resources operative to scan the at least one mapped interactive environment, and the processor further operative to convert the received plurality of viewing data for rendering on one or more client devices.

### CROSS-REFERENCE TO RELATED APPLICATIONS

This application is based upon and claims the benefit of priority from Provisional Application No. 60/822,053 filed Aug. 10, 2006, the entire contents of which are incorporated herein by reference.

### FIELD

The present disclosure relates generally to a computing and communications infrastructure for interactive activities, and in particular but not exclusively, relates to a system and methods for the representation and virtual transportation of locations, products and services, and the consummation of interactions including transactions between vendors and consumers.

### BACKGROUND

The rapid and dramatic growth of Internet usage for a wide variety of applications has provided users with many compelling opportunities to perform research, to review a vast array of information from around the world and to engage in various forms of commerce. The opportunities on the Internet, however, have also resulted in the proliferation of a diverse array of computing devices such as new personal computers, portable computers, hand-held devices and various Internet-enabled appliances. Furthermore, many retail and wholesale vendors have elected to build and deploy a plethora of portals and websites on the Internet in a determined effort to obtain an increasing share of the business and consumer transactions that occur on the Internet.

Such proliferation of devices, portals and websites combined with successive and not necessarily compatible versions of operating systems and application languages has created an operating environment that imposes limitations and barriers to entry on many prospective consumers around the world. Unfortunately, these technical limitations are occurring while there are increasing demands for international commerce in global markets. Vendors around the world seek to expand the reach of their product and service sales while also containing expansion costs. However, many vendors at all levels of distribution will soon face inherent technical and operational business limitations that will prevent the widespread deployment, adoption, distribution and support of their products and services on a global basis.

Thus, there is a need for a system and methods that will enable vendors, employees and customers to gain access to specific locations worldwide using real-time projections and/or virtual representations of market-specific products and services without geographic limitations.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A is block diagram illustrating a computing and communications infrastructure comprised of multiple client devices and remote locations, each location having a plurality of server devices in an embodiment.

FIG. 1B is a block diagram illustrating the components of a server device in an embodiment.

FIG. 1C is a block diagram illustrating the components of a client device in an embodiment.

FIG. 1D is a block diagram illustrating the components of a server application module included in a server device in an embodiment.

FIG. 1E is a block diagram illustrating the components of a client application module included in a client device in an embodiment.

FIG. 2 is a flow chart illustrating a method for accessing, navigating and interacting with an interactive environment in an embodiment.

FIG. 3A is a flow chart illustrating a method for enrolling, training and deploying candidate employees into an interactive environment in an embodiment.

FIG. 3B is a flow chart illustrating a method for enrolling employees and assigning location and product resources in an interactive environment in an embodiment.

FIG. 4 is a flow chart illustrating a method for authenticating a user of an interactive environment in an embodiment.

FIG. 5 is a flow chart illustrating a method for activating and obtaining assistance in an interactive environment in an embodiment.

FIG. 6 is a flow chart illustrating a method for initializing a viewing system and assigning viewing resources in an interactive environment in an embodiment.

FIG. 7 is a flow chart illustrating a method for routing user viewing requests in an interactive environment in an embodiment.

FIG. 8 is a flow chart illustrating a method for mapping a location into an interactive environment in an embodiment.

FIG. 9 is a flow chart illustrating a method for capturing and transmitting viewing images in an interactive environment in an embodiment.

FIG. 10 is a flow chart illustrating a method for receiving and displaying a location in an interactive environment in an embodiment.

### DETAILED DESCRIPTION

Various embodiments of the present disclosure provide a system and methods for a computing and communications infrastructure that will enable automated or human users to engage, interact with and consummate a variety of transactions with remote locations. The locations are projected to users on display devices using real-time projections or virtual representations of the locations and the products and services provided therein. The remote locations will be mapped to ensure that they are fully interactive environments and a plurality of viewing resources will be placed in each location to enable the owners of the locations to control the viewing and navigation experience of users as they are routed through these environments.

Alternative embodiments of the present disclosure provide for the off-site or “home based” recruitment and training of employees and assistants and the deployment of live or virtual (i.e., computer generated) representations of the employees and assistants that are created and projected into the interactive environments at each remote location. Users interact with the representations of the employees and assistants that are deployed to specific locations with local knowledge of applicable products and services as they navigate the interactive environments. Dynamic load balancing is employed to ensure the availability of sufficient viewing resources for all users navigating any location within a mapped interactive environment.

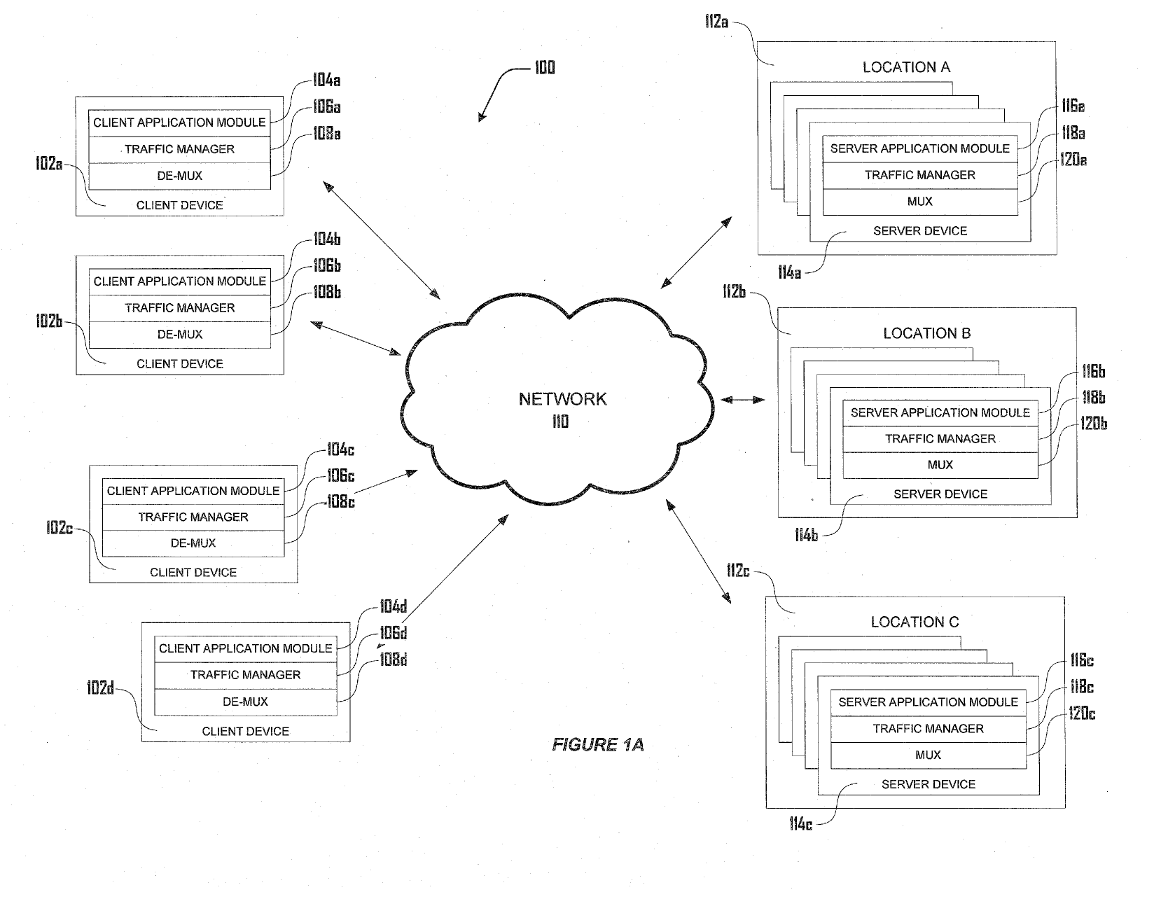

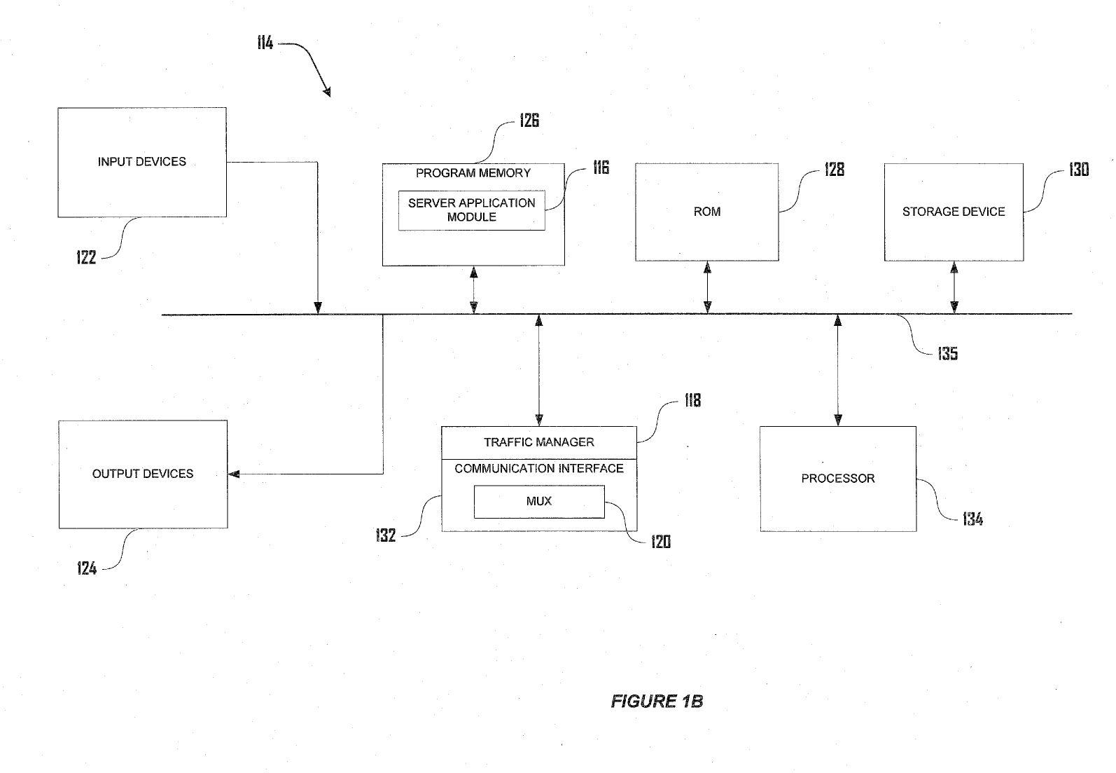

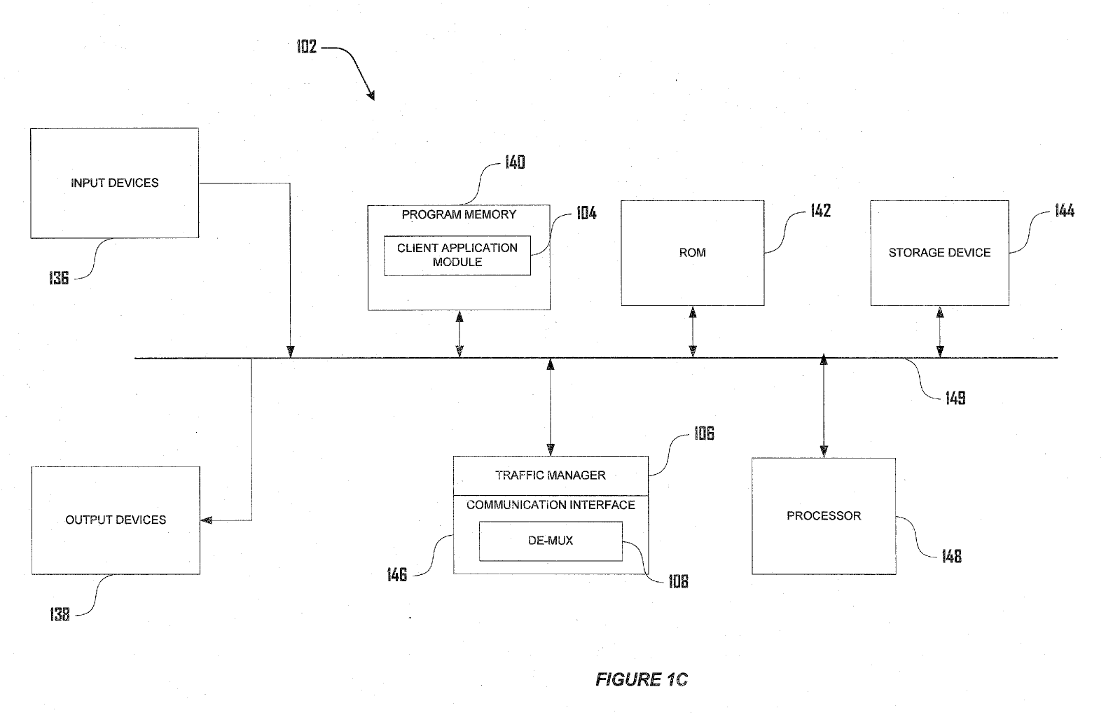

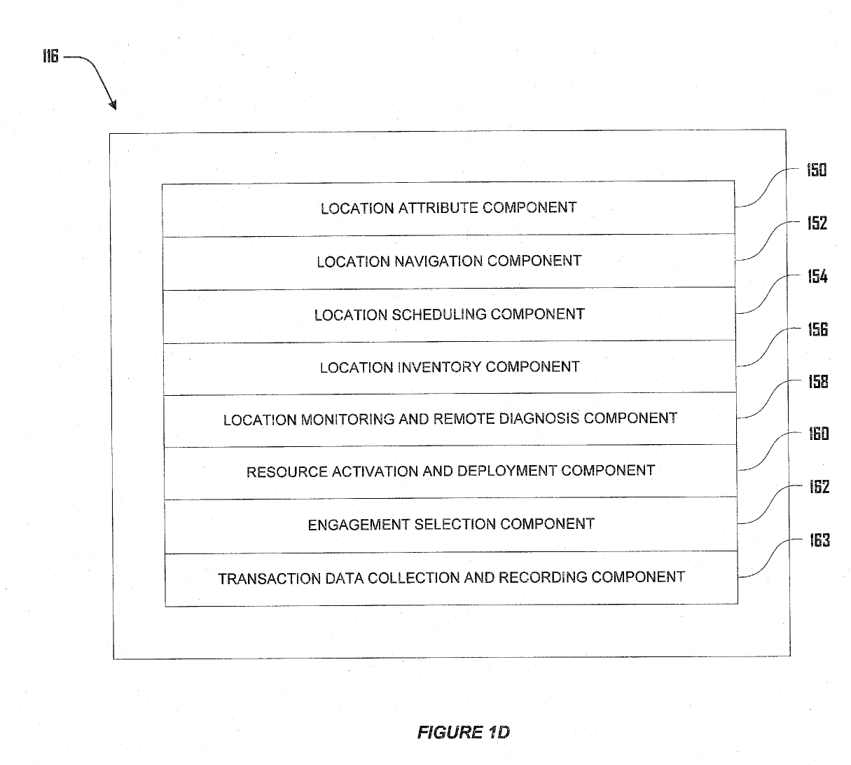

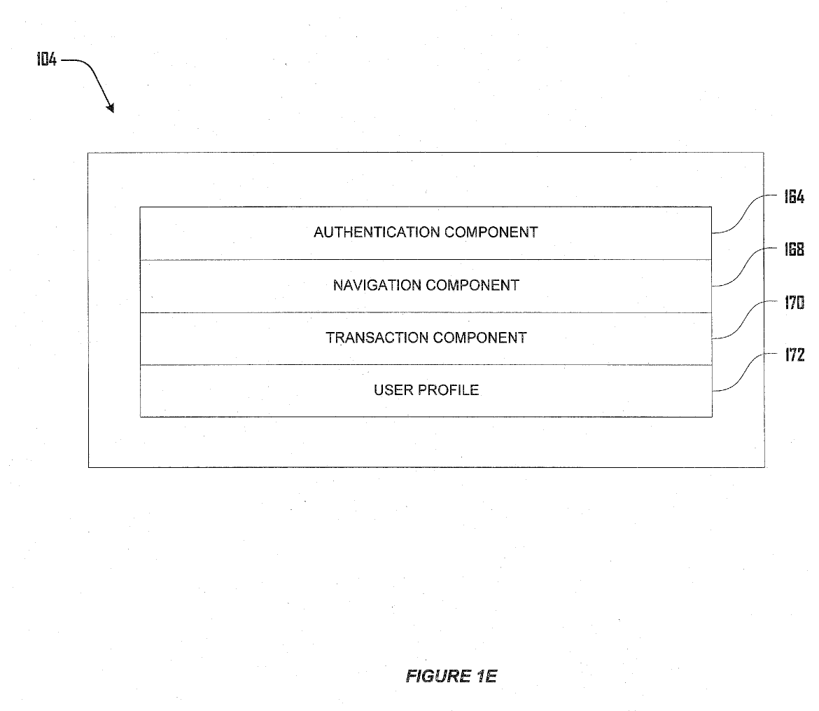

FIG. 1A illustrates a system 100 comprised of a plurality of client devices 102a, 102b, 102c and 102d, a network 110 and a plurality of locations 112a, 112b and 112c. Each location 112 provides an interactive environment with a vast array of viewing resources that permit a user to view and interact with products and related services. Each of the client devices 102 communicates with each location 112 through network 110. In an embodiment, the network 110 is the Internet; however, other networks such as cellular networks, private intranets and WI-FI networks can be used. Each client device 102 is coupled to or includes at least one display device and includes three modules. Specifically, client device 102a includes client application module 104a, traffic manager 106a, and de-multiplexer 108a. Likewise, client device 102b also includes a client application module 104b, a traffic manager 106b, and a de-multiplexer 108b. Client devices 102c and 102d include their respective client application modules 104c, 104d, traffic managers 106c, 106d, and de-multiplexers, 106c, 106d.

As illustrated, Location A 112a includes a plurality of server devices in which a first server device 114a provides a server application module 116a, a traffic manager 118a, and multiplexer 120a. In a preferred embodiment only server device 114a includes server application module 116a, a traffic manager 118a and multiplexer 120a. Likewise, Location B 112b includes a plurality of server devices of which only server device 114b includes a server application module 116b, traffic manager 118b and multiplexer 120b. Location C 112c also includes a plurality of server devices of which server device 114c includes a similar set of modules, a server application module 116c, traffic manager 118c and multiplexer 120c. Each server device 114 is communicatively coupled to each of the other server devices provided in each location through a local area network in a preferred embodiment. However, only server device 114 in each location includes a server application module, a traffic manager, and a multiplexer. Network 110 may be the Internet, a virtual private network, a satellite network or any other proprietary network available for inter-processor communication between computing systems located at diverse geographic locations.

FIG. 1B illustrates a block diagram of a server device 114. As shown, each server device 114 includes one or more input devices 122, one or more output devices 124, a program memory 126, a read only memory 128, a storage device 130, a processor 134, a traffic manager 118, and a communication interface 132 which includes a multiplexer 120 for encoding traffic data streams from one or more of the servers provided at a location. Each program memory 126 stores a server application module 116 for execution on processor 134. Each one of the foregoing elements is communicatively coupled via a common bus 135. In an embodiment, one or more of the server devices 114 are coupled to a compatible host platform.

The elements comprising each client device 102 are illustrated in FIG. 1C. As shown, each client device 102 includes a plurality of input devices 136, a plurality of output devices 138, a program memory 140 including a client application module 104, a read only memory 142, a storage device 144, a processor 148, a traffic manager 106, and a communication interface 146. Among the plurality of output devices 138 are one or more display devices. In an embodiment, the plurality of input devices 136 includes one or more configurable user interfaces for receipt of varying types of data (manual hand entered data, speech data, etc.). The communication interface 146 includes a de-multiplexer 108 for receiving traffic data streams for decoding. Each one of the foregoing elements provided in client device 102 is coupled to a common bus 149 for exchange of data and commands. In an embodiment, one or more of the client devices 102 are coupled to a compatible host platform.

FIG. 1D illustrates a block diagram of a server application module 116, which in a preferred embodiment is a software application comprised of a plurality of software components. In the present case, the server application module 116 is comprised of a location attribute component 150, a location navigation component, a location scheduling component 154, a location inventory component 156, a location monitoring and remote diagnosis component 158, a resource activation and deployment component 160, and an engagement selection component 162. Location attribute component 150 provides the owner of a location with the means for setting attributes such as but not limited to product type, product pricing, product placement, and product viewing options. Location navigation component 152 provides the location owner with the resources to set the controls required by users to enable them to navigate throughout the locations controlled by the location owner. The location scheduling component 154 enables the location owner to establish a daily, weekly, or monthly schedule for the type of representation to be displayed and projected onto a user's display device. For instance, on each weekday morning the owner may elect to project a real-time projection of a location including goods and identifiable services to a user on one or more display devices owned by the user. In the afternoon on each weekday, the location owner may elect to project only virtual representations of the locations owned or controlled by the owner. Furthermore, the location scheduling component 154 can be used to enable an owner of a location to specify a hybrid representation of a location or products included at a location, which could be a combination of a real-time projection and a virtual projection of the locations and products that are owned or controlled by the owner.

Location inventory component 156 includes an active real-time listing of the product inventory in each location owned or controlled by a location owner. Location monitoring and remote diagnosis component 158 provides owner-specified and automatically executed remote diagnostic resources. These monitoring and diagnostics resources are employed to identify and contain problems with viewing systems, navigational capabilities, or other computing and communications problems at owner controlled locations. Resource activation and deployment component 160 is used to activate viewing resources in specific locations and to facilitate the deployment of real-time or virtual representations of employees or assistants assigned to specific locations for the purpose of assisting users as they view and navigate specific locations. Engagement selection component 162 enables a client device 102 shown in FIG. 1C to be under the control of a user to view products or information on services available in an interactive environment at a specific location. This component also enables a user to navigate the location and to view the products or services of interest to the user that may be present in the location. Transaction data collection and recording component 163 monitors all data collection activity and records all attempted and completed transactions. This component provides an independent means for verifying and auditing all transactions that occur in the interactive environment at each location.

FIG. 1E is a block diagram illustrating the components included in each client application module 104. The authentication component 164 enables the client device 102 to authenticate the identity of a user. Navigation component 168 manages the processes and system required to enable a user to navigate the interactive environments within a location 112 using available viewing resources and control systems. Transaction component 170 registers and maintains an active log of all transactions performed by a user in each interactive environment navigated by the user. User profile 172 manages a data store that includes all information pertaining to the identity and selection preferences of a user.

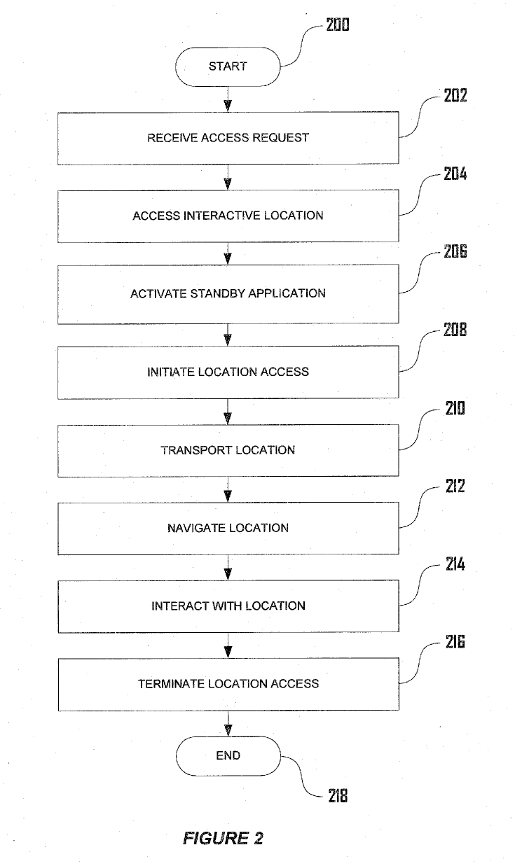

FIG. 2 provides a flowchart for a method performed by the system 100 shown in FIG. 1. The process starts at step 200 and begins with the receipt of an access request 202 from a user. The user may be an automated process or a human user that seeks access to one or more interactive environments at a location 112 for the purpose of viewing products and services and consummating one or more transactions in each environment. After receipt of an access request, a process is initiated to provide access to an interactive environment at a location 112 (i.e., an “interactive location”), as shown at step 204. The server application module 116 is activated as shown at step 206 and a location access is initiated, as shown at step 208. If location access is provided, the accessed location is transported to a display device for use by a user, as shown at step 210, and navigation of the selected interactive environment begins, as shown at step 212. While the user views products and information on services and is routed through the accessed interactive location, the user interacts with one or more of the products and services as shown at step 214. A user's interaction with such products and services may include viewing or purchasing the products and services in the location. After completion of a product or service interaction, access to the interactive location will be terminated, as shown at step 216, and the process will conclude, as shown at step 218.

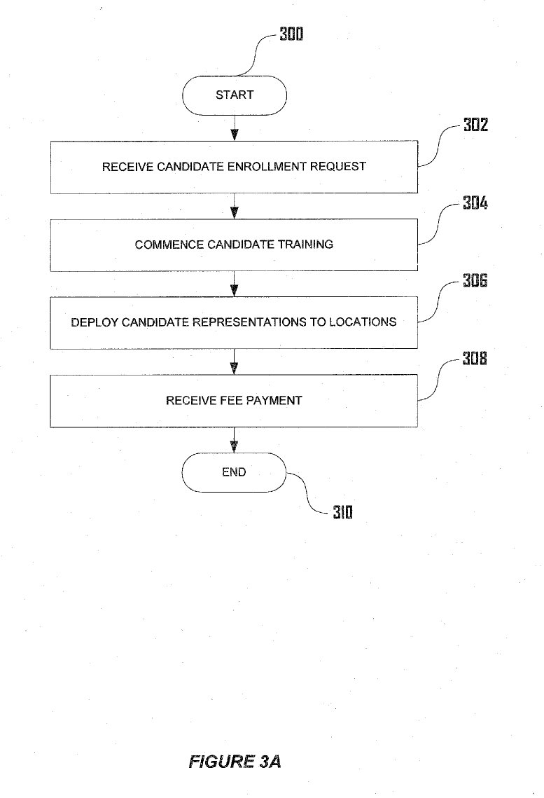

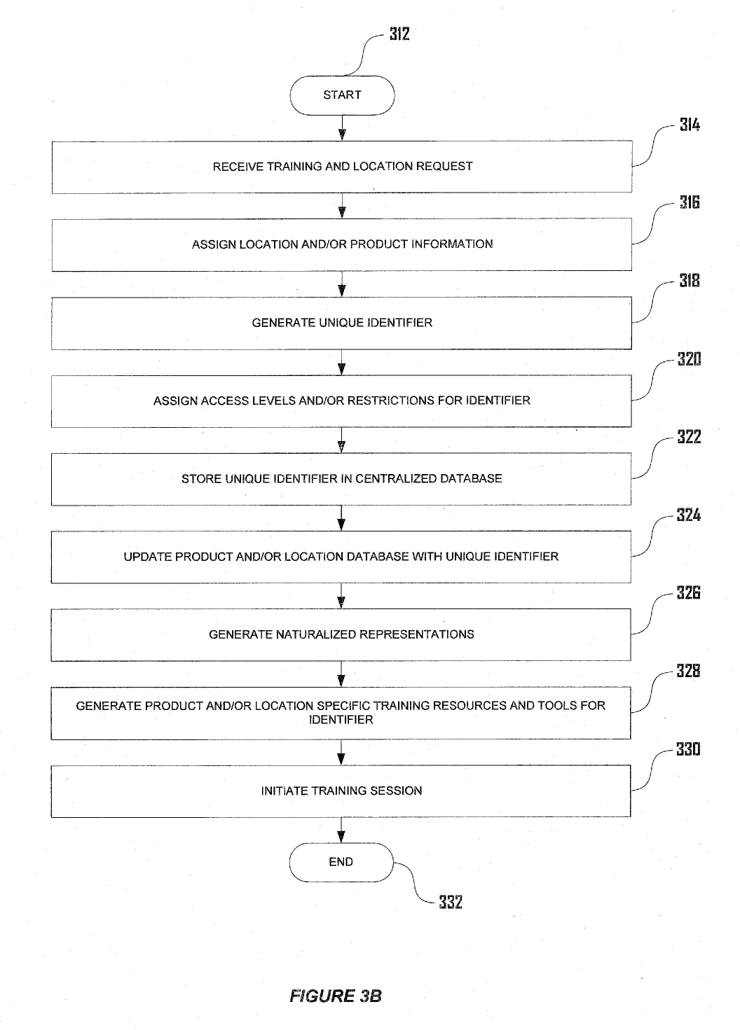

FIG. 3A illustrates the flowchart for the process of enrolling new employees. The process commences as step 300 and begins with the receipt of a candidate enrollment request as shown at step 302. A new candidate will begin candidate training as shown at step 304, which will involve a series of training sessions focused on products available at the locations designated as being of interest to a new candidate. The flowchart illustrated in FIG. 3B sets forth in greater detail the training and deployment process referred to in FIG. 3A at step 304. Upon completion of candidate training, the one or more naturalized representations which are created by the new employee will be “deployed” to locations that are designated by the new candidate, as shown at step 306. In one embodiment, the process of enrolling a new candidate also involves the payment of a new candidate fee, which will be used to defray the cost of enrolling and training new employees and assistants on the products and services available at each specially designated location made available by the owner of the location, as shown at step 308. Upon completion of the enrollment and candidate representation process and the payment of a fee for enrolling new employees, the process completes as shown at step 310.

FIG. 3B illustrates a process for training new employees and assistants on products and services available in specific locations. The process commences, as shown at step 312, with the receipt of a training and location request, as shown at step 314. After receipt of this request, a location and/or product information will be assigned to the requesting party, as shown at step 316. After receipt of the request and the assignment of location and product information, a unique identifier will be generated, as shown at step 318. After issuance of the unique identifier 318, an access level and/or pertinent restrictions will be assigned to the identifier, as shown at step 320, and the identifier will be stored in a centralized database, as shown at step 322. After storage of the identifier, the product and location database will be updated by storing a new association with the newly stored unique identifier, as shown at step 324. Upon updating the products and location database, one or more naturalized representations of the requesting party will be generated, as shown at step 326, and related location-specific training resources will be provided to the requesting party to whom the unique identifier has been assigned, as shown at step 328. The training resources provided to the requesting party are specialized resources that are specific to the products available in the locations where the requesting party's representation is to be deployed. Training tools and advanced educational seminars are generated and/or compiled that will be specific to existing products as well as upcoming improvements to featured products. Upon generation of the product and location-specific training resources and tools, and the creation of naturalized representations for each trained employee, a location and product specific training session will be initiated, as shown at step 330. Afterwards, the training and location request process will come to an end, as shown at step 332.

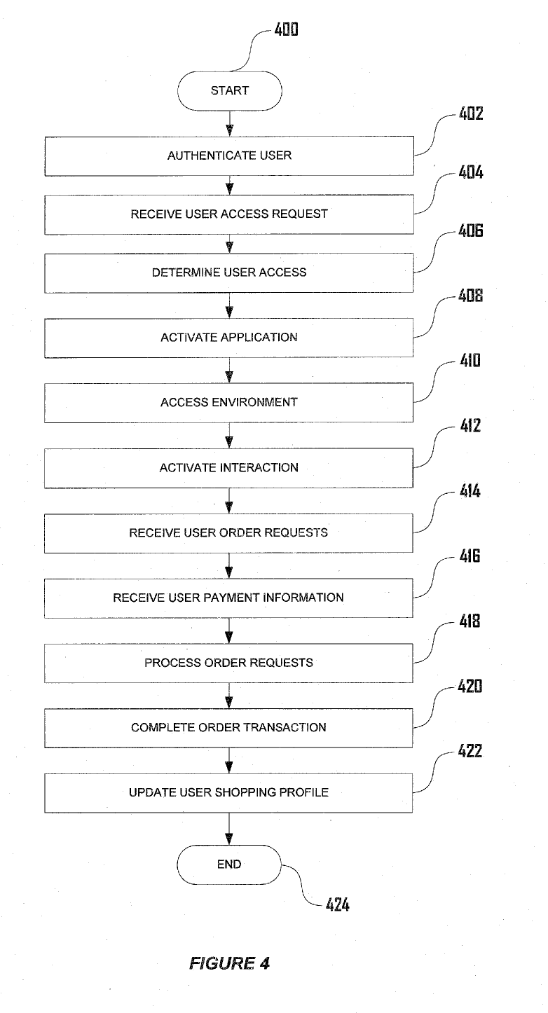

FIG. 4 illustrates a flowchart for a process of authenticating a user and completing transactions requested by a user. The process commences as shown at step 400 and first involves the authentication of a user as shown at step 402 and the receipt of a user access request as shown at step 404. Upon receipt of the access request 404, the level of access to a location will be determined based on a pre-assigned user access key, as shown at step 406, and then an application specific to an interactive environment will be activated, as shown at step 408. After application activation 408, access will be provided to the interactive environment, as shown at step 410, and an interaction will be activated, as shown at step 412. An interaction 412 is a continuous process between one or more servers at a designated location 112 and a user who gains access to the servers with use of a client device 102. User order requests are received as shown at step 414 for specific products or services available in the interactive environment and user payment information is received as shown at step 416, if a user desires to purchase one or more products or services available in the interactive environment. Order requests are processed as shown at step 418 and one or more transactions are completed as shown at step 420. A user's profile 172 will be updated to reflect the purchase transaction completed during the current routing and navigation session in the interactive environment, as shown at step 422, and then the process ends, as shown at step 424.

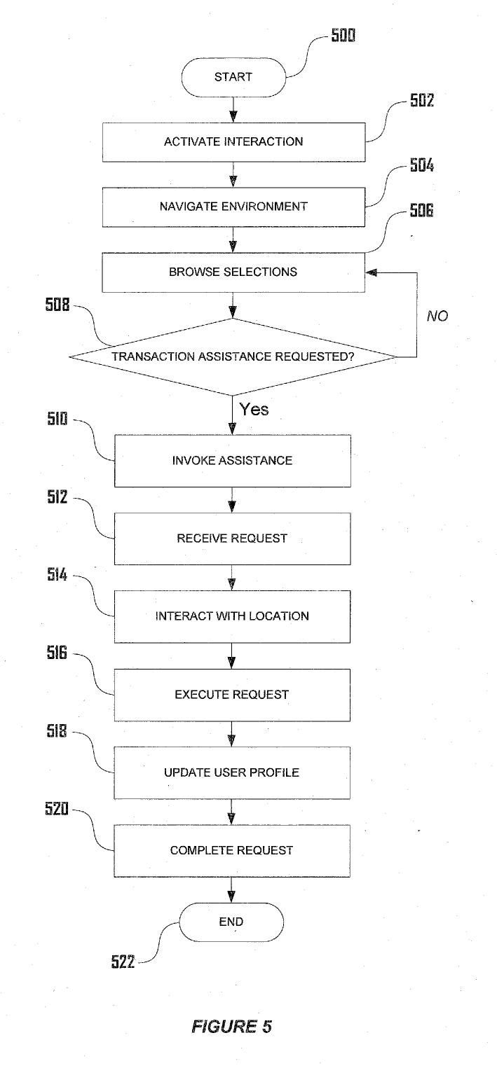

FIG. 5 is a flowchart illustrating in greater detail the assistance that can be provided by employees or other assistants to users who navigate an interactive environment. The process begins at step 500 with an activation of an “interaction,” as shown at step 502. As indicated above, an interaction 502 is a continuous interactive session between one or more server devices 114 at a location 112 and a client device 102 that is used by a user. The user (either an automated process or human user) proceeds to navigate the interactive environment as shown at step 504 and to make browsing selections, as shown at step 506. As the user is browsing selections in the interactive environment 504, the user will be queried to determine if transaction assistance is required, as shown at step 508. If no such assistance is requested, then the user is permitted to continue browsing selections, as shown at step 506.

However, if transaction assistance is requested, then a location-specific assistance process will be invoked, as shown at step 510. Assistance can be provided in several different modes, including live human assistance, delayed human assistance, recorded human assistance or virtual agent assistance. The mode of assistance can be applied in any of several different types of interactive environments, as scheduled and pre-determined by the owner of the locations that are being navigated by users. The types of interactive environments that can be displayed include real-time environments, delayed transmission environments, recorded environments and virtual environments. Any of the different modes of assistance can be superimposed in any of the types of interactive environments. Thus, “live” human assistance can be superimposed in a virtual interactive environment as well as in a delayed transmission environment. Likewise, virtual assistance can be superimposed in a recorded environment or in an entirely virtual interactive environment.

After a request for assistance is provided and transaction assistance is invoked, a selection request is received from the user, as shown at step 512, which will pertain to one or more of the products and services available in the interactive environment. An interaction with the location will be commenced, as shown at step 514, in which the user actively reviews products and services in different interactive environments provided in one or more navigable locations that satisfy the selection request using available viewing resources in the interactive environment. The execution of a product or service specific request for assistance, as shown at step 516, includes opening or displaying a product, purchasing the product or service, or reviewing certain product-related information available in a portion of the interactive location. After the request is received and executed, the user's profile 172 will be updated with information on the products and services for which assistance was provided, as shown at step 518, and the request for product or service specific assistance will be completed, as shown at step 520. Afterwards, the invoked transaction assistance process will come to an end, as shown at step 522; however, the user may continue to navigate the environment and browse other selections during the activated “interaction” which was commenced previously, as indicated at step 502.

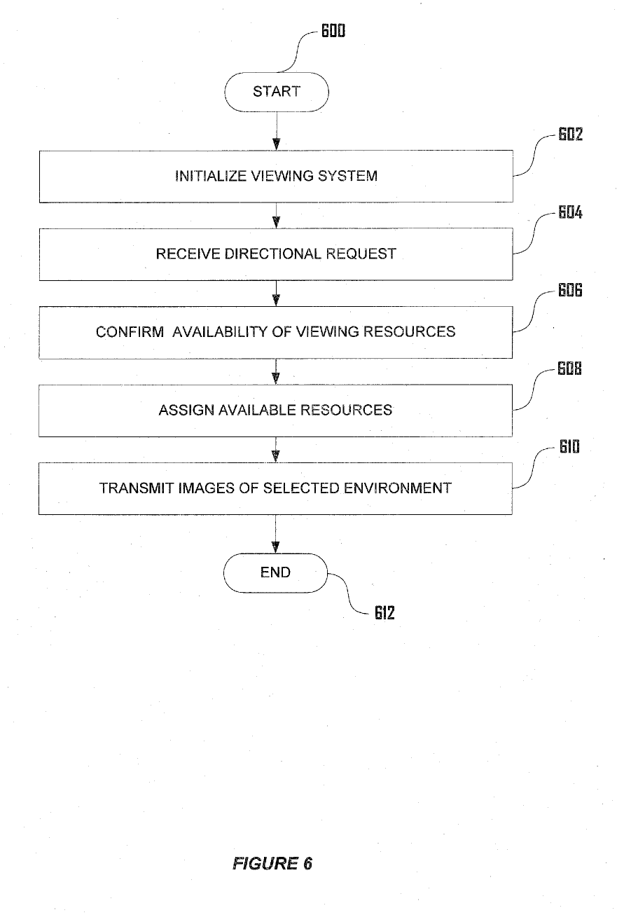

FIG. 6 illustrates a flowchart for initializing a viewing system and identifying available resources for a user to enable the navigation of an interactive environment. The process commences, as shown at step 600, and involves the initialization of viewing system, as shown at step 602, and the receipt of a directional request from a user, as shown at step 604. Available viewing resources will be confirmed to ensure that they are available for use with and response to directional requests from the user, as shown at step 606 and then these viewing resources will be assigned to the user to fulfill the directional requests, as shown at step 608. Images generated from the viewing resources in a specific location in the selected interactive environment can be transmitted to a display device coupled to a client device 102, which is indicated at step 610. The display device can be desktop computer monitor, the display of a handheld device or other professional or consumer device capable of receiving, processing and displaying images and other alphanumeric or multimedia information. After transmission of images from a selected interactive environment, the process of initializing and assigning viewing resources will end as shown at step 612.

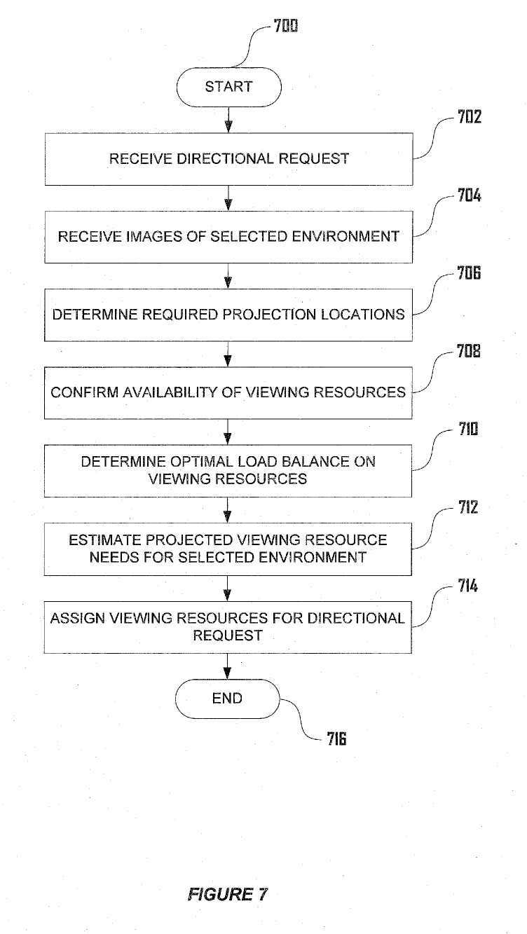

FIG. 7 depicts a flowchart for assigning viewing resources and routing users through an interactive environment. The process begins as step 700 and commences with the receipt of a directional request as shown at step 702. Images from the selected interactive environment are received as shown at step 704 and relayed to a client device 102. Since a plurality of viewing resources are available in the interactive environment, the generation and transmission of location-specific projections of images from the interactive environment for all available products and services available in the environment will be important. Thus, a key step involves determining the required projection location, as shown at step 706, and the confirmation of available viewing resources to view the products and services available in specific locations that are to be projected and viewed on the user's display device. The confirmation of available viewing resources occurs at step 708 and is followed by the execution of a process to determine the optimal load balance on viewing resources, as shown at step 710, given the demands on all other viewing resources from all other users who may be routed through the same location in the interactive environment. In addition to determining current load balance and other computational requirements for viewing available products and services, an estimate will also be performed to determine projected viewing resources that will be needed to support the user and to anticipate the routing of the user's directional requests through the interactive environment, as shown at step 712. Viewing resources will be assigned to a user based on the current load balance among available viewing resources and the projected need for viewing resources in the interactive environment, as shown at step 714. After determining current and projected viewing resource requirements for routing through the interactive environment, the process will terminate as shown at step 716.

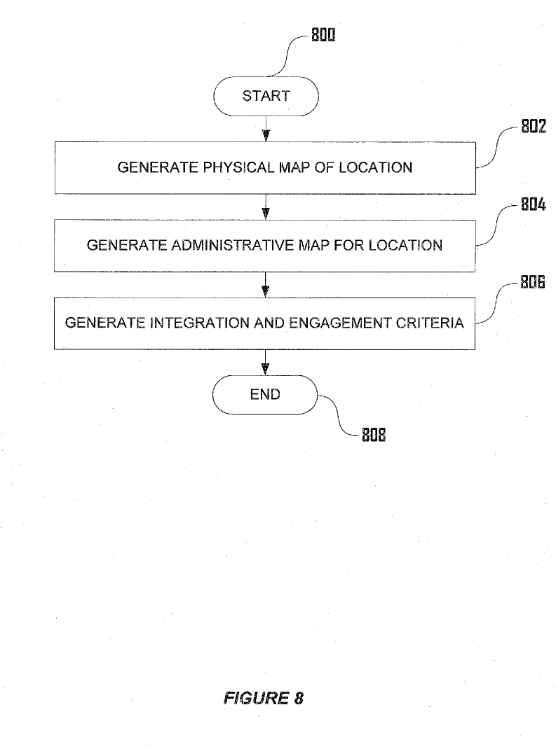

An important and complex part of the present disclosure involves the mapping of geographic locations to ensure that they are fully interactive environments. The mapping of each location requires the deployment of a significant number of portable viewing resources, which are coupled together via a local network to ensure that “viewer-perspective” projections of products and services are portrayed on each user's display device. As shown in FIG. 8, the process of mapping an interactive location begins at step 800 and first involves the generation of a physical map of the location as shown at step 802. The physical mapping of the location involves determining, among other things, the mapping of products and their locations, the total number of viewing resources to be made available in each interactive environment at a specific location, the routing requirements among viewing resources, and the estimated computational load on the viewing resources. In addition to the physical mapping of each location, an administrative map for a location is generated to enable the owner of an interactive location to effectively control the routing of users through each interactive environment within a location. Administrative mapping is performed to ensure that there is maximum opportunity to route and navigate all users throughout the interactive environment and to ensure that all available products and information pertaining to services can be viewed by all users at all times as they are routed through these environments, as shown at step 804. A key part of determining the operability of an interactive environment for each location is the generation of integration and engagement criteria, as shown at step 806, which involves the determination of specific steps or criteria that must be satisfied to enable a user to interact with products and services available in an interactive environment. After generation of the criteria, the process is completed as shown at step 808.

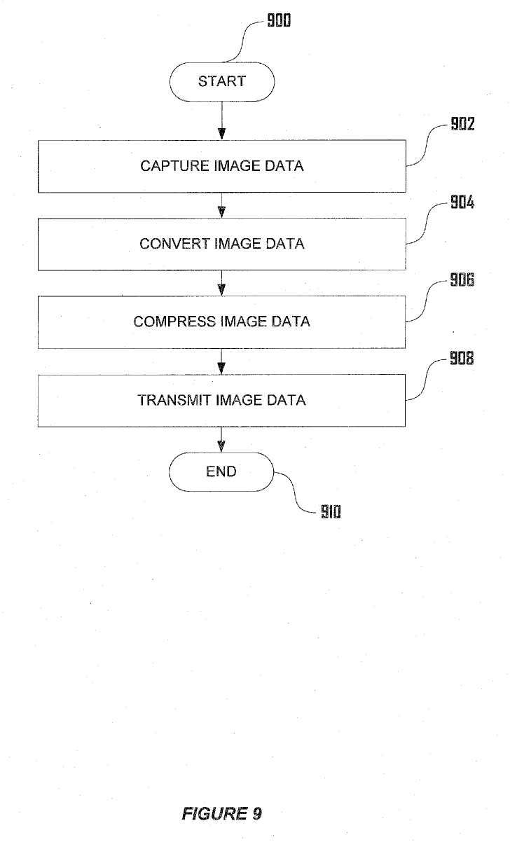

FIG. 9 illustrates a method for capturing and transmitting images from viewing resources in an interactive environment. The process commences at step 900 and involves the capture of image data (generally referred to as viewing data) as shown at step 902 and the conversion of the image data as shown at step 904 for compression and transmission. The converted image data is compressed as shown at step 906 and transmitted over the network 110 to a de-multiplexer 108 in a client device 102 and then the process completes as shown at step 910. The transmission of image data as shown at step 908 involves the multiplexing of image data from one or more of the available viewing resources in a specific portion of or location in an interactive environment. Each location represents a different viewing perspective from a plurality of independent users, whether those users are automated processes or human users. Various means can be used for the transmission of image data and each such means represents a form of distribution.

In an embodiment, a variable time delay is imposed between the conversion of the viewing data and its distribution to one or more client devices 102. In an alternative embodiment, a variable time delay is imposed between the capture of the viewing data and the conversion of the data. These variable time delays are imposed for the purpose of managing the distribution of custom converted content for users who place requests for content using the client devices 102. The viewing data produced from the viewing resources are received and stored in various formats, protocols and configurations and include meta-data that represents the semantic content in the written and spoken information in the data. Depending on the access request generated from the client devices 102, the conversion process performed at step 904 will produce conversions of the formats, protocols, configurations and semantic content in response to the received access request. As used here, the term “protocol” refers to the rules for transmission of data while the term “configuration” refers to the structure of the data (e.g., data structures) that are to be converted. Conversion of semantic content embedded in the viewing data includes conversion of oral and written content while preserving the original intent and meaning of the content included in the viewing data.

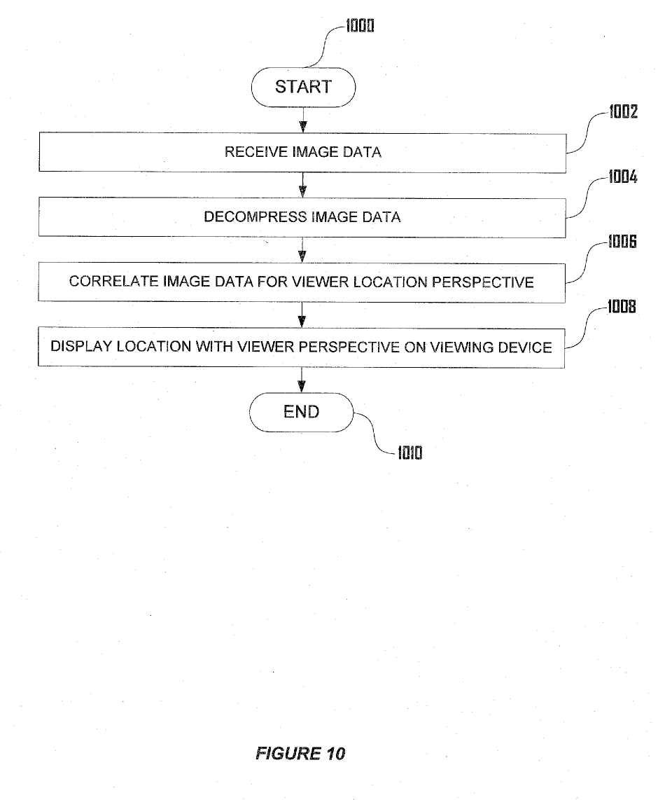

FIG. 10 illustrates the process for receiving, decompressing and displaying image data on a display device coupled to the client device 102. As shown, the process commences at step 1000 and involves receiving image data as shown at step 1002 and the decompression of the image data as shown at step 1004 and a subsequent correlation of image data to ensure the viewer sees on the display device the location in an interactive environment from the right viewing perspective, as shown at step 1006. After correlation, the integrated image is displayed on a display device based on the viewing perspective of the viewer in the interactive environment, as shown at step 1008. After display of the correlated image, the process comes to an end as shown at step 1010. Operationally, image data is received, shown at step 1002, at each de-multiplexer 108 and subsequently transmitted to a display device coupled to a client device 102. The de-multiplexer 108 ensures that only the image data of the requesting user will be displayed on the display device. In an alternative embodiment, one de-multiplexer 108 is provided use by two or more client devices 102, in which the de-multiplexer 108 decodes image data streams for different users using different client devices 102 to increase the throughput of the system while minimizing decoding time on each client device 102.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What I claim is:

1. A method of content conversion and distribution, the method comprising:
receiving an access request from a client device;
accessing at least one mapped interactive environment determined from the received access request;
scanning the at least one mapped interactive environment using one or more viewing resources included in the at least one mapped interactive environment, the viewing resources generating a plurality of viewing data;
converting the viewing data for rendering on the client device; and
distributing the converted viewing data to the client device.

2. The method of claim 1 wherein the viewing resources include a plurality of cameras in the at least one mapped interactive environment.

3. The method of claim 2 wherein the viewing resources further include at least one representation of an assistant, the assistant operative to assist a user in navigating the mapped interactive environment.

4. The method of claim 3 wherein the at least one representation of the assistant is a virtual representation.

5. The method of claim 3 wherein the at least one representation of the assistant is a real-time video representation.

6. The method of claim 1 wherein the viewing data includes representations of products and descriptions of one or more information services.

7. The method of claim 6 wherein the products are physical products and virtual products.

8. The method of claim 7 wherein the viewing resources provide a plurality of image data of the interactive environment and a plurality of perspective data on the representations of the products as a user navigates the interactive environment.

9. The method of claim 1 wherein the converting of the viewing data occurs concurrently with the distributing of the viewing data to the client device.

10. The method of claim 1 wherein the converting of the viewing data commences a variable time delay before the distributing of the viewing data to the client device.

11. The method of claim 1 wherein the converting of the viewing data commences a variable time delay after the scanning of the mapped interactive environment.

12. The method of claim 1 wherein the viewing data comprises at least one data format and wherein the converting of the viewing data comprises converting one or more of the at least one data formats of the viewing data.

13. The method of claim 1 wherein the converting of the viewing data comprises converting a semantic content of the viewing data.

14. The method of claim 1 wherein the converting of the viewing data comprises converting at least one protocol of the viewing data generated from the viewing resources.

15. The method of claim 1 wherein the converting of the viewing data comprises converting at least one configuration of the viewing data generated from the viewing resources.

16. The method of claim 1 wherein the viewing data is distributed in real-time with the scanning of the interactive environment and the converting of the viewing data.

17. The method of claim 1 wherein the mapped interactive environment is represented in a real-time projection including one or more products and services.

18. The method of claim 1 wherein the mapped interactive environment is represented in a virtual representation including virtual representations of one or more products and services.

19. A method of content conversion and distribution, the method comprising:
receiving an access request from a client device;
accessing at least one mapped interactive environment determined from the received access request;
scanning the at least one mapped interactive environment using one or more viewing resources included in the at least one mapped interactive environment, the viewing resources generating a plurality of viewing data;
distributing the viewing data to the client device; and
converting the distributed viewing data for rendering on the client device.

20. The method of claim 19 wherein the converting of the distributed viewing data occurs on the client device.

21. The method of claim 19 wherein the viewing resources include a plurality of cameras in the at least one mapped interactive environment.

22. The method of claim 21 wherein the viewing resources further include at least one representation of an assistant, the assistant operative to assist a user in navigating the mapped interactive environment.

23. The method of claim 22 wherein the at least one representation of the assistant is a virtual representation.

24. The method of claim 22 wherein the at least one representation of the assistant is a real-time video representation.

25. The method of claim 19 wherein the viewing data includes representations of products and descriptions of one or more information services.

26. The method of claim 25 wherein the products are physical products and virtual products.

27. The method of claim 26 wherein the viewing resources provide a plurality of image data of the interactive environment and a plurality of perspective data on the representations of the products as a user navigates the interactive environment.

28. The method of claim 19 wherein the viewing data is distributed in real-time with the scanning of the interactive environment and the converting of the viewing data.

29. The method of claim 19 wherein the mapped interactive environment is represented in a real-time projection including one or more products and services.

30. The method of claim 19 wherein the mapped interactive environment is represented in a virtual representation including virtual representations of one or more products and services.

31. A content conversion and distribution apparatus comprising:
a memory;
a processor coupled to the memory, the processor operative to:
receive an access request from a client device;
access at least one mapped interactive environment determined from the received access request;
scan the at least one mapped interactive environment using one or more viewing resources included in the at least one mapped interactive environment, the viewing resources generating a plurality of viewing data;
convert the viewing data for rendering on the client device; and
distribute the converted viewing data to the client device.

32. The content conversion and distribution apparatus of claim 31 wherein the viewing resources include a plurality of cameras in the at least one mapped interactive environment.

33. The content conversion and distribution apparatus of claim 32 wherein the viewing resources further include at least one representation of an assistant, the assistant operative to assist a user in navigating the mapped interactive environment.

33. The content conversion and distribution apparatus of claim 33 wherein the at least one representation of the assistant is a virtual representation.

34. The content conversion and distribution apparatus of claim 33 wherein the at least one representation of the assistant is a real-time video representation.

35. The content conversion and distribution apparatus of claim 31 wherein the viewing data includes representations of products and descriptions of one or more information services.

36. The content conversion and distribution apparatus of claim 35 wherein the products are physical products and virtual products.

37. The method of claim 36 wherein the viewing resources provide a plurality of image data of the interactive environment and a plurality of perspective data on the representations of the products as a user navigates the interactive environment.

38. The method of claim 31 wherein the processor is operative to convert the viewing data concurrently with the distributing of the viewing data to the client device.

39. The method of claim 31 wherein the processor converts the viewing data a variable time delay before the processor distributes the viewing data to the client device.

40. The method of claim 31 wherein the processor converts the viewing data a variable time delay after the processor scans the mapped interactive environment.

41. The method of claim 31 wherein the viewing data comprises at least one data format and wherein the converting of the viewing data comprises converting one or more of the at least one data formats of the viewing data.

42. The method of claim 31 wherein the processor is operative to convert a semantic content of the viewing data.

43. The method of claim 31 wherein the processor is operative to convert at least one protocol of the viewing data generated from the viewing resources.

44. The method of claim 31 wherein the processor is operative to convert at least one configuration of the viewing data generated from the viewing resources.

45. The method of claim 31 wherein the viewing data is distributed in real-time with the scanning of the interactive environment and the converting of the viewing data.

46. The method of claim 31 wherein the mapped interactive environment is represented in a real-time projection including one or more products and services.

47. The method of claim 31 wherein the mapped interactive environment is represented in a virtual representation including virtual representations of one or more products and services.

48. A content conversion apparatus comprising:
a memory;
a processor coupled to the memory, the processor operative to:
generate a request for access to at least one mapped interactive environment;
receive a plurality of viewing data generated from one or more viewing resources included in the at least one mapped interactive environment, the viewing resources operative to scan the at least one mapped interactive environment; and
convert the received plurality of viewing data.

49. The content conversion apparatus of claim 48 wherein the viewing resources include a plurality of cameras in the at least one mapped interactive environment.

50. The content conversion apparatus of claim 49 wherein the viewing resources further include at least one representation of an assistant, the assistant operative to assist a user in navigating the mapped interactive environment.

51. The content conversion apparatus of claim 50 wherein the at least one representation of the assistant is a virtual representation.

52. The content conversion apparatus of claim 50 wherein the at least one representation of the assistant is a real-time video representation.

53. The content conversion apparatus of claim 48 wherein the viewing data includes representations of products and descriptions of one or more information services.

54. The content conversion apparatus of claim 53 wherein the products are physical products and virtual products.

55. The content conversion apparatus of claim 54 wherein the viewing resources provide a plurality of image data of the interactive environment and a plurality of perspective data on the representations of the products as a user navigates the interactive environment.

56. The content conversion apparatus of claim 48 wherein the viewing data is distributed in real-time with the scanning of the interactive environment and the converting of the viewing data.

57. The content conversion apparatus of claim 48 wherein the mapped interactive environment is represented in a real-time projection including one or more products and services.

58. The content conversion apparatus of claim 48 wherein the mapped interactive environment is represented in a virtual representation including virtual representations of one or more products and services.

59. A computer readable medium having instructions for performing the method of claim 1.

60. A computer readable medium having instructions for performing the method of claim 19.
